(19) United States
(12) Patent Application Publication
(10) Pub. No.: US 2010/0149367 A1
(43) Pub. Date: Jun. 17, 2010

(54) DIGITAL IMAGE SIGNAL PROCESSING APPARATUS AND METHOD OF DISPLAYING SCENE RECOGNITION

(75) Inventors: Hyun-ock Yim, Suwon-si (KR); Soon-geun Jang, Suwon-si (KR); Ung-sik Kim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/633,002

(22) Filed: Dec. 8, 2009

(30) Foreign Application Priority Data
Dec. 17, 2008 (KR) 10-2008-0128634

(51) Int. Cl. H04N 5/228; G06K 9/68

(52) U.S. Cl. 348/222.1; 382/218; 348/E05.031

(57) ABSTRACT

A method of displaying scene recognition of a digital image signal processing apparatus includes generating an input image, recognizing a scene of the input image, producing a frame image corresponding to the recognized scene, synthesizing the frame image and the input image to generate an output image, and displaying the output image on a display unit.

### CROSS-REFERENCE TO RELATED PATENT APPLICATIONS

This application claims the priority benefit of Korean Patent Application No. 10-2008-0128634, filed on Dec. 17, 2008, in the Korean Intellectual Property Office, the disclosure of which is incorporated herein in its entirety by reference.

### BACKGROUND

1. Field of the Invention

The present invention relates to a method of controlling a digital image signal processing apparatus that performs scene recognition of a photographed image, and a digital image signal processing apparatus employing the method.

2. Description of the Related Art

There are digital cameras capable of recognizing a photographed scene which automatically display an icon or text corresponding a recognized scene on an LCD. However, when a text is displayed together with a photographed image, an effect of displaying the photographed image is deteriorated. Also, when an icon is displayed together with a photographed image, it is ineffective unless a user is familiar with the meaning of the icon.

### SUMMARY

Exemplary embodiments include a method of displaying scene recognition of a digital image signal processing apparatus capable of recognizing a scene of a photographed image and effectively displaying the photographed image with information on a recognized scene, and a digital image signal processing apparatus employing the method.

An exemplary method of displaying scene recognition of a digital image signal processing apparatus includes generating an input image, recognizing a scene of the input image, producing a frame image corresponding to the recognized scene, synthesizing the frame image and the input image to generate an output image, and displaying the output image on a display unit.

The frame image and the input image may be presented as image data in a same storage format.

The method may further include adjusting transparency of the frame image, wherein the frame image having the adjusted transparency is synthesized with the input image to generate the output image.

The method may further include generating the frame image, setting the generated frame image as a frame image corresponding to a scene, and generating a database regarding the generated frame image according to the scene.

The database may include at least one frame image corresponding to a scene.

The method may further include deriving a first frame image corresponding to a first scene.

The method may further include changing the first frame image to a second frame image, produced with respect to the first scene.

Generating the input image may include photographing an object.

The method may further include generating an image file including the output image, and storing the image file on a storage medium.

The method may further include generating a plurality of output images by synthesizing the input image and the frame image corresponding to the recognized scene by varying transparency of the frame image corresponding to the recognized scene, generating an image file including the plurality of output images, and storing the image file on a storage medium.

Generating a plurality of output images may include generating a first output image having a first resolution by synthesizing the input image and the frame image having a first transparency, and generating a second output image having a second resolution by synthesizing the input image and a second frame image having a second transparency.

The first transparency may decrease as the first resolution increases.

The image file may further include a third output image having a third resolution, the third output image including the input image without a frame image.

The method may further include restoring at least one of output images from the image file, and displaying a restored output image.

The method may further include receiving an input magnification control signal, wherein restoring the at least one of the output images includes restoring an output image having a resolution according to the magnification control signal.

The method may further include receiving an input preview control signal, wherein restoring the at least one of the output images includes restoring an output image having a relatively low resolution according to the preview control signal.

An exemplary digital image signal processing apparatus includes an input image generation unit configured to generate an input image, a scene recognition unit communicatively coupled with the input image generation unit and configured to recognize a scene from the input image, a frame image production unit communicatively coupled with the scene recognition unit and configured to produce a frame image corresponding to the recognized scene, an output image generation unit communicatively coupled with the input image generation unit and the frame image production unit, the output image generation unit configured synthesize the frame image and the input image to generate an output image, and a display control unit communicatively coupled with the output image generation unit and configured to control the output image to be displayed on a display unit.

The frame image and the input image may be presented as image data in a same storage format.

The digital image signal processing apparatus may further include a frame image setting unit configured to set a frame image to correspond to a type of scene.

The digital image signal processing apparatus may further include a database configured to store a frame image according to a type of the scene.

The database may be further configured to store a plurality of frame images corresponding to a scene, and the digital image signal processing apparatus may further include a frame image changing unit configured to change a first frame image corresponding to the scene to a second frame image corresponding to the scene.

The digital image signal processing apparatus may further include a transparency adjustment unit configured to adjust transparency of the frame image, and a synthesis unit configured to generate an output image by synthesizing the frame image and the input image.

The synthesis unit may be further configured to generate a plurality of output images, the plurality of the output images including a plurality of frame images having different transparencies from each other.

The synthesis unit may be further configured to generate a first output image having a first resolution including the input image and a first frame image having a first transparency, and a second output image having a second resolution including the input image and a second frame image having a second transparency.

The synthesis unit may be further configured to generate a third output image having a third resolution including input image without a frame image.

The digital image signal processing apparatus may further include an encoder communicatively coupled with the output image generation unit and configured to generate an image file including the output image.

The digital image signal processing apparatus may further include a decoder configured to restore the output image from an image file.

The decoder may be further configured to restore the output image having a relatively high resolution according to a magnification control signal, and the display control unit may be further configured to control a display unit to display the restored output image.

The decoder may be further configured to restore the output image having a relatively low resolution according to a preview control signal, and the display control unit may be further configured to control a display unit to display the restored output image.

### BRIEF DESCRIPTION OF THE DRAWINGS

The above and other features and advantages of the present invention will become more apparent by describing in detail exemplary embodiments thereof with reference to the attached drawings listed below:

FIG. 1 is a block diagram of an exemplary digital camera as a digital image signal processing apparatus.

FIG. 2 is a block diagram of an exemplary digital signal processing unit in the digital camera of FIG. 1.

FIG. 3 is a block diagram of another exemplary digital signal processing unit in the digital camera of FIG. 1.

FIG. 4 is a block diagram of another exemplary digital signal processing unit in the digital camera of FIG. 1.

FIG. 5 is a block diagram of another exemplary digital signal processing unit in the digital camera of FIG. 1.

FIG. 6 is a flowchart for explaining an exemplary method of displaying scene recognition of a digital image signal processing apparatus.

FIGS. 7 and 8 are images showing examples of a frame image generated by a user.

FIGS. 9 and 10 are images showing examples of an output image.

FIGS. 11-13 are images showing other examples of output images generated by synthesizing a frame image in a predetermined area of an input image.

FIG. 14 is an image showing an example of an output image generated by synthesizing a frame image having a flicker effect and a photographed image.

FIG. 15 is a flowchart for explaining another exemplary method of displaying scene recognition of a digital image signal processing apparatus.

FIG. 16 illustrates an example of the structure of an image file including a thumbnail image, the original image, and a screennail image generated by an exemplary method of displaying scene recognition.

FIGS. 17-19 are images corresponding the structure of the image file of FIG. 16.

FIG. 20 illustrates another example of the structure of an image file including three sorts of screennail images and the original image generated by an exemplary method of displaying scene recognition.

FIG. 21 illustrates the original image of FIG. 20.

FIG. 22 illustrates the first screennail image of FIG. 20.

FIG. 23 illustrates the second screennail image of FIG. 20.

FIG. 24 illustrates the third screennail image of FIG. 20.

FIGS. 25-27 are images for explaining exemplary steps of reproducing the image file of FIG. 20 in a digital camera.

FIG. 28 illustrates output images generated in an exemplary method of displaying scene recognition, and displayed in a preview mode in a digital camera.

FIG. 29 illustrates output images generated in an exemplary method of displaying scene recognition, and displayed in a preview mode on an external monitor.

FIG. 30 is a flowchart for explaining another exemplary method of displaying scene recognition in a digital image signal processing apparatus.

### DETAILED DESCRIPTION

The attached drawings for illustrating exemplary embodiments of the present invention are referred to in order to gain a sufficient understanding of the present invention, the merits thereof, and the objectives accomplished by the implementation of the present invention. Hereinafter, exemplary embodiments of the invention will be explained with reference to the attached drawings. Like reference numerals in the drawings denote like elements.

In the following description, a digital camera is described as an embodiment of a digital image signal processing apparatus. However, the digital image signal processing apparatus is not limited to the digital camera and may include digital apparatuses such as camera phones, personal digital assistants (PDAs), or portable multimedia players (PMPs) which have a camera function.

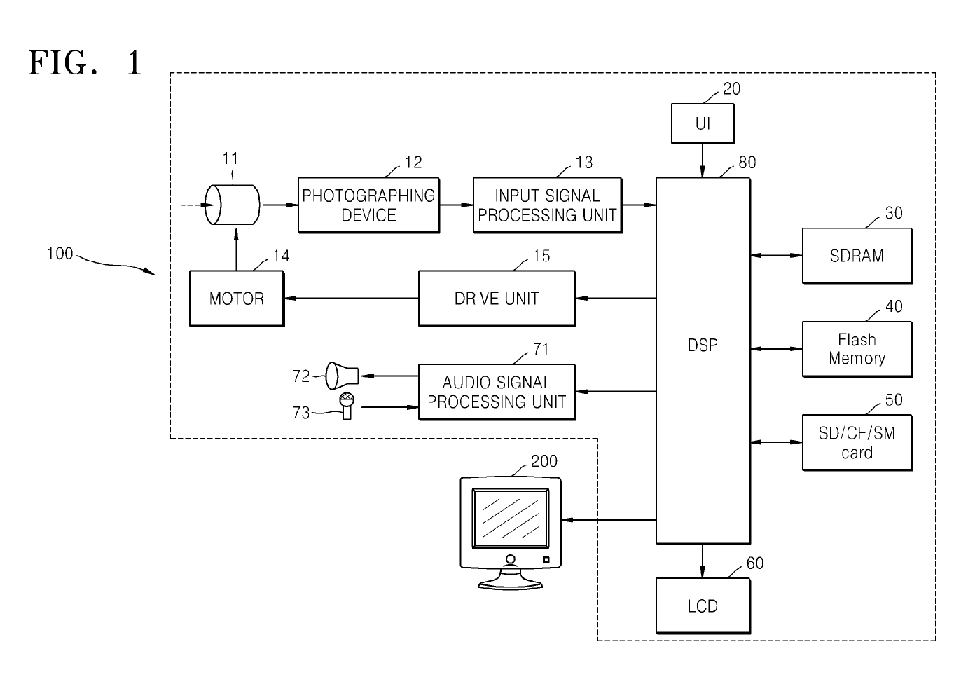

FIG. 1 is a block diagram of an exemplary digital camera 100 as a digital image signal processing apparatus. Referring to FIG. 1, the digital camera 100 may include an optical unit 11 configured to receive an input optical signal from an object (not shown), a photographing device 12 configured to convert the optical signal input through the optical unit 11 to an electrical signal, and an input signal processing unit 13 configured to perform noise reduction processing of the electrical signal provided by the photographing device 12 as well as signal processing such as converting the electrical signal to a digital signal. The digital camera 100 may also include a motor 14 configured to drive the optical unit 11 and a drive unit 15 configured to control the operation of the motor 14. Also, the digital camera 100 may include a user input unit 20 as user interface (UI) configured to accept an operation signal input from a user. The digital camera 100 may also include an SDRAM 30 as a storage medium configured to temporarily store data of an input image corresponding to the input optical signal, data for processing an operation, or a processing result. The digital camera 100 may also include a flash memory 40 as a storage medium configured to store an algorithm or setting data used in an operation of the digital camera 100, and a Secure Digital (SD)/CompactFlash (CF)/SmartMedia (SM) card 50 as a storage medium configured to store an image file. Other formats and technologies as known in the art may also be used in place of the SD/CF/SM card 50 for storing the image file. The digital camera 100 may also include an LCD 60 as a display unit. The digital camera 100 may also includes an audio signal processing unit 71 configured to convert sound to a digital signal, convert a digital signal of a sound source to an analog signal, or generate an audio data file. The audio signal processing unit 71 may be coupled with a speaker unit 72 configured to output sound and a microphone 73 configured to input sound. The digital camera 100 may also include a digital signal processing unit (DSP) 80 configured to control the operation of the digital camera 100.

The optical unit 11 may include a lens (not shown) configured to focus an input optical signal, an aperture (not shown) configured to adjust the amount of the optical signal (or light) which passes through the optical unit 11, and a shutter (not shown) configured to control input of the optical signal through the optical unit 11. The lens may include a zoom lens configured to control a view angle to increase or decrease according to a focal length and a focus lens configured to focus the input optical signal from the object. These lenses may be provided as an individual lens or in a group of a plurality of lenses. A mechanical shutter moving up and down may be used as the shutter. The role of the shutter may be performed by controlling the supply of an electric signal to the photographing device 12, instead of providing a separate shutter device.

The motor 14 driving the optical unit 11 may drive movement of the lens, opening/shutting of the aperture, and operation of the shutter to perform auto-focusing, auto-exposure control, aperture control, zooming, and manual focusing. The motor 14 may be controlled by the drive unit 15. The drive unit 15 may control the operation of the motor 14 according to a control signal input from the DSP 80.

The photographing device 12 may receive an optical signal output from the optical unit 11, form an image of the object, and output an electrical signal representing the image of the object to the input signal processing unit 13. The photographing device 12 may include a complementary metal oxide semiconductor (CMOS) sensor array or a charge coupled device (CCD) sensor array.

The input signal processing unit 13 may further include an A/D converter (not shown) configured to digitize an analog electrical signal supplied by the photographing device 12, such as by a CCD. Also, the input signal processing unit 13 may further include a circuit configured to perform signal processing to adjust gain or regulate a waveform of the electrical signal provided by the photographing device 12.

The UI 20 may include a member for a user to manipulate the digital camera 100 or control settings for photography. For example, the member may be embodied in buttons, keys, a touch panel, a touch screen, or a dial so that a user control signal for power on/off, photography start/stop, reproduction start/stop/search, driving an optical system, changing modes, manipulating a menu, or selection may be input.

The SDRAM 30 may temporarily store raw data (e.g., RGB data) of an image provided by the input signal processing unit 13. The temporarily stored raw data may undergo a predetermined image signal processing or be transmitted to another constituent element according to the operation of the DSP 80. Also, data representing an algorithm and stored in the flash memory 40 may be converted to executable data (e.g., a program) and temporarily stored in the SDRAM 30. The data stored in the SDRAM 30 may be processed by the DSP 80 so that an operation according to the algorithm may be performed. Also, the image file stored in the flash memory 40 may be decompressed and temporarily stored in the SDRAM 30. The temporarily stored image data may be transmitted to the LCD 60 so that a predetermined image may be displayed. For example, a variety of volatile memories temporarily storing data during which power is supplied, or a semiconductor device formed by integrating a plurality of memory devices may be used as the SDRAM 30.

The flash memory 40 may store an operating system (OS) needed for operating the digital camera 100, application programs, and data for executing an algorithm of a control method of the present invention. For example, a variety of non-volatile memories such as ROM may be used as the flash memory 40.

The SD/CF/SM card 50 may record an image file that is generated by compressing image data provided by the input signal processing unit 13. For example, hard disk drives (HDDs), optical disks, opto-magnetic disks, or holographic memories may be used instead of the SD/CF/SM card 50.

The LCD 60 may display an image corresponding to the image data provided by the input signal processing unit 13 in real-time or display an image corresponding to image data restored from the image file stored in the SD/CF/SM card 50. Although the LCD 60 is described in the present embodiment, the present invention is not limited thereto and an organic electroluminescence display device or an electrophoretic display may be used therefor.

The audio signal processing unit 71 may convert a digital signal of a sound source provided by the DSP 80, amplify the sound, and output the amplified sound to the speaker unit 72. The audio signal processing unit 71 may input sound through the microphone 73, convert the sound to a digital signal and compress the converted digital signal, and generate an audio file. The generated audio file may be transmitted to the DSP 80 so that a predetermined operation may be performed with respect to the audio file.

The DSP 80 may reduce noise with respect to the input image data and perform image signal processing such as gamma correction, color filter array interpolation, color matrix, color correction, or color enhancement. Also, the DSP 80 may generate an image file by compressing the image data generated by performing the image signal processing, or may generate image data from the image file. The image compression format may be reversible or irreversible. For example, the conversion to a Joint Photographic Experts Group (JPEG) format or a JPEG 2000 format may be available. Also, the DSP 80 may functionally perform sharpness processing, color processing, blur processing, edge emphasis processing, image analysis processing, image recognition processing or image effect processing. Scene recognition processing may be performed with the image recognition processing. Also, the DSP 80 may perform display image signal processing to display an image on the LCD 60. For example, the DSP 80 may perform image synthesis processing such as brightness level control, color correction, contrast control, edge emphasis control, screen division processing, or character image generation. The DSP 80 may be connected to an external monitor 200 as a display unit. The DSP 80 may perform predetermined image signal processing to display an image on the external monitor 200. The DSP 80 may be controlled to transmit the processed image data to the external monitor 200 so that the image may be displayed on the external monitor 200.

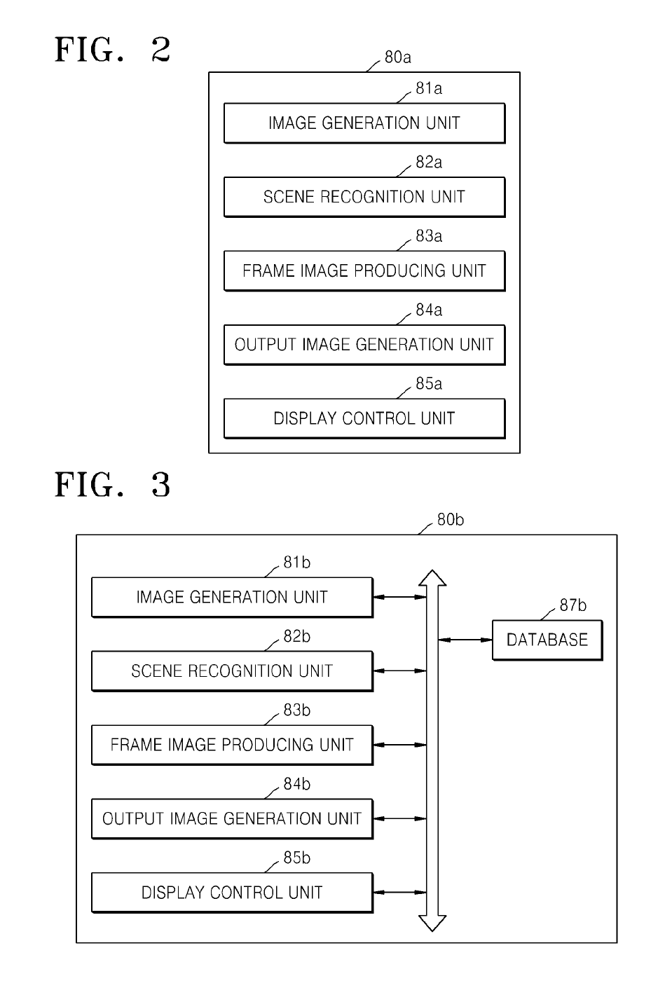

The DSP 80 may perform the above-described image signal processing and may control each constituent element according to a result of the processing. Also, the DSP 80 may control each constituent element according to the user control signal input through the UI 20. An algorithm to perform the image signal processing may be stored in the flash memory 40. The algorithm may be converted to executable data for processing an operation and stored in the SDRAM 30. Accordingly, the DSP 80 may perform an operation corresponding to the executable data. Also, the DSP 80 may control the LCD 60 to display a scene recognized during a scene recognition mode. The control operation of the DSP 80 will be described in detail with reference to FIGS. 2-5.

FIG. 2 is a block diagram of an exemplary DSP 80a. Referring to FIG. 2, the DSP 80a includes an image generation unit 81a configured to generate an input image, a scene recognition unit 82a configured to recognize a scene with respect to the input image, a frame image producing unit 83a configured to produce a frame image corresponding to the recognized scene, an output image generation unit 84a configured to synthesize the frame image and the input image to generate an output image, and a display control unit 85a configured to control display of the output image.

The image generation unit 81a may generate an input image by performing at least one of image signal processing such as noise reduction processing, gamma correction, color filter array interpolation, color matrix, color correction, or color enhancement, with respect to image data input through the optical unit 11 and the input signal processing unit 13. The scene recognition unit 82a may recognize a scene situation such as portrait, landscape, night view, or sports from the input image.

The frame image producing unit 83a may produce a frame image corresponding to the recognized scene. In the present embodiment, the frame image includes a mark for a user to recognize the recognized scene. For example, a mark that a user designates may be used as the frame image. In the present embodiment, the frame image may be stored in the SD/CF/SM card 50. An image file including the frame image and information as to which scene the frame image corresponds may be stored in the SD/CF/SM card 50. For example, the image file including the frame image may be stored in an exchangeable image file format (Exif). The frame image and the input image may be compressed and stored in the same format. For example, the frame image and the input image may be stored in the SD/CF/SM card 50 in a JPEG image file format. That is, the frame image and the input image may be presented as image data of the same storage format. Thus, the frame image producing unit 83a may produce an image file having information about the recognized scene from the SD/CF/SM card 50 and a frame image by decompressing the recognized image file.

The output image generation unit 84a may generate an output image by synthesizing the input image and the produced frame image. The display control unit 85a may control the LCD 60 to display the output image on the LCD 60. The display control unit 85a may perform image signal processing for the display of the output image. Thus, the user may recognize a scene of the input image by seeing the frame image of the output image displayed on the LCD 60.

FIG. 3 is a block diagram of an exemplary DSP 80b. Referring to FIG. 3, the DSP 80b according to the present embodiment includes an image generation unit 81b configured to generate an input image, a scene recognition unit 82b configured to recognize a scene with respect to the input image, a frame image producing unit 83b configured to produce a frame image corresponding to the recognized scene, an output image generation unit 84b configured to synthesize the frame image and the input image to generate an output image, and a display control unit 85b configured to control the display of the output image. The DSP 80b may further include a database 87b configured to store a list of frame images according to the scene.

The database 87b may include a list showing the relation of a scene to at least one of the frame images. Thus, the frame image producing unit 83b may produce information about a frame image corresponding to the recognized scene from the database 87b and the frame image from the SD/CF/SM card 50 from the information. The list having a plurality of frame images corresponding to a scene may be stored in the database 87b. Information about priority among the frame images or user defined information may be stored together.

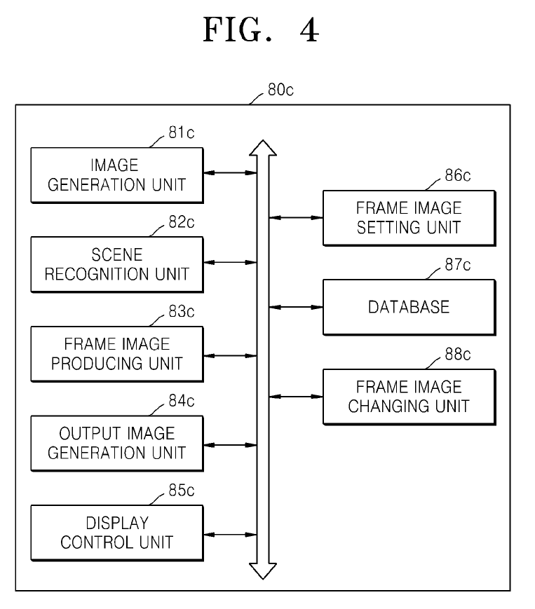

FIG. 4 is a block diagram of an exemplary DSP 80c. Referring to FIG. 4, the DSP 80c according to the present embodiment includes an image generation unit 81c configured to generate an input image, a scene recognition unit 82c configured to recognize a scene with respect to the input image, a frame image producing unit 83c configured to produce a frame image corresponding to the recognized scene, an output image generation unit 84c configured to synthesize the frame image and the input image to generate an output image, and a display control unit 85c configured to control display of the output image.

The DSP 80c may further include a frame image setting unit 86c configured to set a frame image. The image generation unit 81c may generate an image with respect to an image signal input through the optical unit 11, the photographing device 12, and the input signal processing unit 13. The frame image setting unit 86c may set the generated image from the image generation unit 81c to a frame image by relating the generated image to a scene. When the generated image is recognized as a specific scene, the frame image setting unit 86c may set the generated image to a frame image according to the user control signal input through the UI 20. The scene recognition unit 82c may set the generated image to a frame image corresponding to the recognized scene.

Also, the frame image setting unit 86c may set a frame image corresponding to a specific scene from images stored in the SD/CF/SM card 50. For example, after checking the images stored in the SD/CF/SM card 50 by reproducing the images on the LCD 60, a user may select one of the images as a frame image indicating a particular scene, such as a night view scene. Thus, the frame image setting unit 86c may set the selected image as a frame image corresponding to the particular scene, in this case a night view scene.

A database 87c may store a list showing the above-described relation between a scene and the frame image. For example, the database 87c may store a list showing the relation between a specific scene and matching information as in Table 1. The storage area of the SD/CF/SM card 50 may be set in relation to the matching information and the image file of the frame image may be stored in each storage area. For example, as shown in Table 2, an image file including a frame image may be stored in a particular storage area according to the matching information. Thus, the frame image setting unit 86c may determine the matching information of an image and store an image file including the image in a storage area corresponding to the matching information. Also, the frame image producing unit 83c may determine matching information of a scene recognized from the database 87c and produce a frame image from an image file in a storage area corresponding to the matching information.

TABLE 1

| Scene | Matching Information |
|---|---|
| Portrait | 1 |
| Night View | 2 |

TABLE 2

| Storage Area | Image File |
|---|---|
| 1 | DCF22123.JPG |
| 2 | DCF22124.JPG |

Also, the DSP 80c may further include a frame image changing unit 88c. The frame image changing unit 88c may be configured to change a frame image according to a scene. As an illustration, in Table 2, the storage area 1 corresponds to the matching information 1 of Table 1, that is, an image file “DCF22123.JPG” is stored in the storage area 1 to correspond to a portrait scene. The frame image changing unit 88c may store another image file in the storage area 1 according to the user's selection. Another image file may be stored in replacement of “DCF22123.JPG”. Also, another image file may be further stored in addition to “DCF22123.JPG” and, when a portrait scene is recognized, the other image file may be set to be primarily selected.

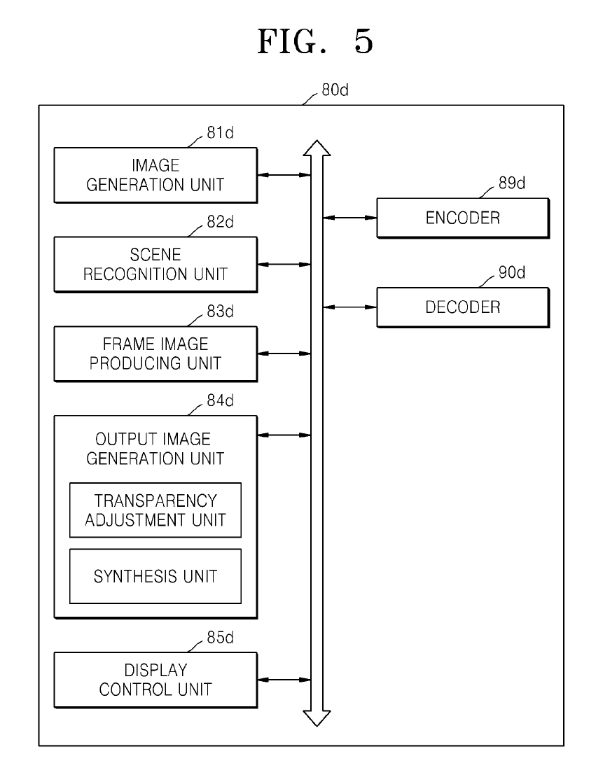

FIG. 5 is a block diagram of another exemplary DSP 80d. Referring to FIG. 5, the DSP 80d according to the present embodiment includes an image generation unit 81d configured to generate an input image, a scene recognition unit 82d configured to recognize a scene with respect to the input image, a frame image producing unit 83d configured to produce a frame image corresponding to the recognized scene, an output image generation unit 84d configured synthesize the frame image and the input image to generate an output image, and a display control unit 85d configured to control display of the output image.

In the present embodiment, the output image generation unit 84d includes a transparency adjustment unit and a synthesis unit. The transparency adjustment unit may adjust transparency of a frame image produced by the frame image producing unit 83d. For example, the transparency of the frame image with respect to an input image may be adjusted at a ratio of 7:3. The synthesis unit may synthesize the input image and the frame image according to a degree of transparency. Thus, an output image may be generated.

The DSP 80d may further include an encoder 89d configured to generate an image file by compressing the output image. Also, the DSP 80d may further include a decoder 90d configured to restore an output image by decompressing the image file. The display control unit 85d may perform signal processing to display the restored output image on the LCD 60.

The transparency adjustment unit may set different transparencies. Accordingly, the synthesis unit may generate a plurality of output images. For example, the transparencies may be set at various values, for example, 3:7, 1:0, or 2:8. Accordingly, three output images may be generated as the synthesis unit synthesizes the input image and the frame image. The first output image may be stored as a thumbnail image. The second output image may be stored as the original image including only an input image. The third output image may be stored together in the image file as a screennail image. As resolution increases, the transparency of the frame image may be increased so that only an input image may be displayed.

Exemplary methods of displaying scene recognition of a digital camera will be described below with reference to flowcharts.

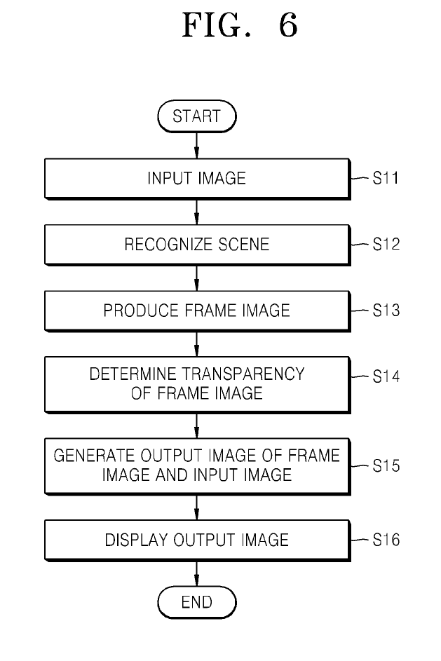

FIG. 6 is a flowchart for explaining an exemplary method of displaying scene recognition of a digital image signal processing apparatus. An exemplary method of displaying scene recognition in a live-view mode where a shutter button of a digital camera is half pressed is described. In other words, a method of displaying scene recognition before photography for recording an image is performed is described.

Referring to FIG. 6, an image may be input (S11). A scene may be recognized from the input image (S12). A frame image according to the recognized scene may be produced (S13). Transparency of the produced frame image may be determined (S14). The frame image and the input image may be synthesized according to the determined degree of transparency to generate an output image (S15). The output image may be displayed (S16).

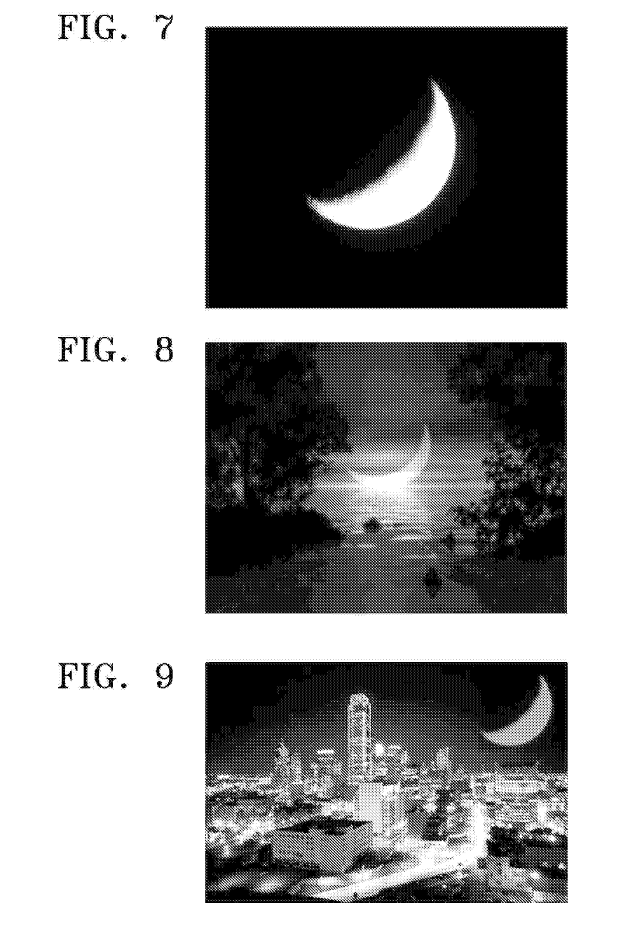

The above-described method illustrated in FIG. 6 will be described in detail with reference to FIGS. 7-14. FIGS. 7 and 8 are images showing examples of a frame image generated by a user. First, a first frame image of FIG. 7 and a second frame image of FIG. 8 may be stored in the SD/CF/SM card 50 or other memory as a mark for indicating a night view. Scene recognition may be performed from an input image restored by decompressing an input image input from the optical unit 11 and the photographing device 12 or an image file stored in the SD/CF/SM card 50. When a night view scene is recognized, at least one of the frame images and the input image may be synthesized to generate an output image.

FIG. 9 is an exemplary first output image generated by synthesizing the first frame image of FIG. 7 and the input image. FIG. 10 is an exemplary second output image generated by synthesizing the second frame image of FIG. 8 and the input image. When a plurality of frame images matched to the night view scene are stored as above, any one of the frame images may be selected by a user or a priority may be given to any one of the frame images.

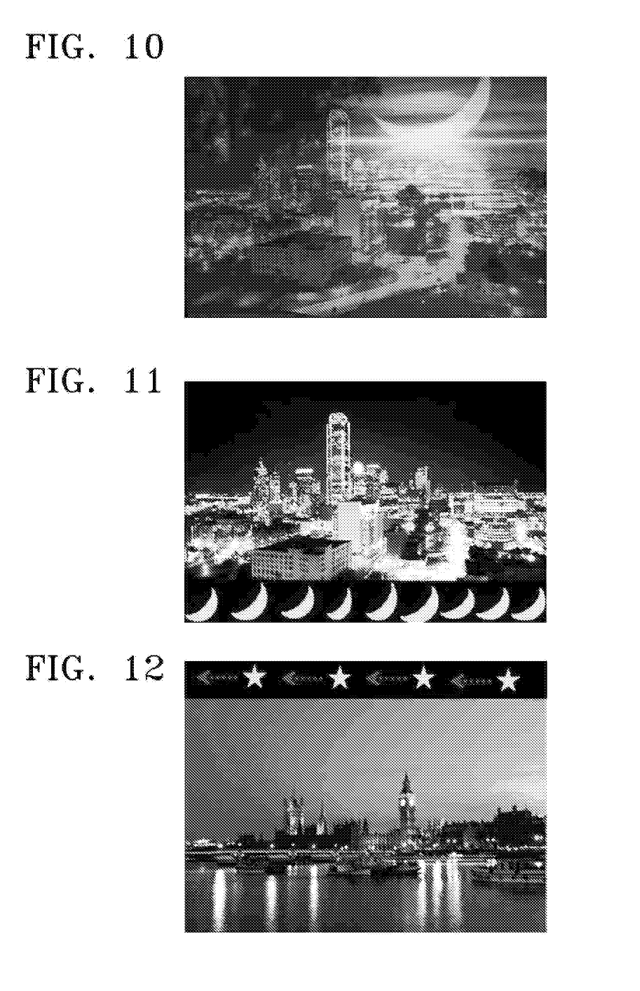

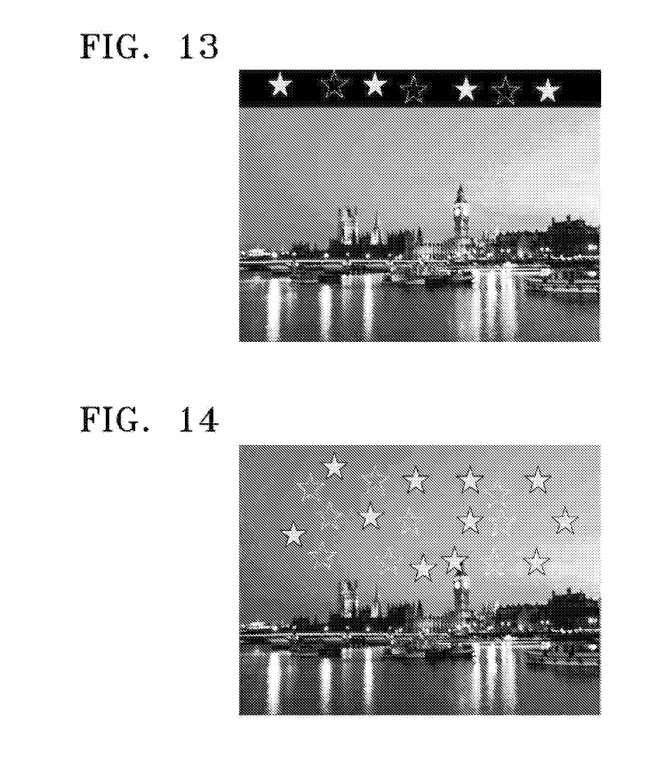

FIGS. 11-13 are images showing other examples of output images generated by synthesizing a frame image in a predetermined area of an input image. FIG. 11 is an exemplary output image in which a plurality of frame images (e.g., that of FIG. 7) are overlapped in a lower end edge of an input image. FIG. 12 is an exemplary output image in which a plurality of frame images are overlapped in an upper end edge of an input image. According to the image of FIG. 12, an edge area is set in the input image and the frame images are overlapped in the edge area. The upper, lower, left, and right directions of the input image may be indicated by giving an effect of movement. FIG. 13 is another exemplary output image in which a plurality of frame images are overlapped in an upper end edge of an input image. In FIG. 13, an edge area is set in the input image as in FIG. 12 and the frame images are overlapped in the edge area so as to generate an output image. However, according to the image of FIG. 13, the output image may be presented by using a blink image for some of the frame images. FIG. 14 is an image showing an example of an output image generated by synthesizing a frame image having a flicker effect and a photographed image. As shown in FIG. 14, the frame images may be overlapped in a predetermined area of the input image and the frame image may have an effect of blinking.

As described above, while the output image may be generated and displayed by overlapping the input image and the frame image in a variety of methods, a user may easily and effectively recognize scene recognition. The output image may be displayed not only on the LCD 60 or in a live-view mode, but also may be stored in an image file and displayed in a reproduction mode.

FIG. 15 is a flowchart for explaining another exemplary method of displaying scene recognition of a digital image signal processing apparatus. Referring to FIG. 15, a photography ready state (S21) may be set. It may be determined whether a photography control signal is input (S22). The photography control signal may generally correspond to a photography start signal that is generated by completely pressing a shutter button. An image of an object may be captured in response to the photography start signal and the image may undergo a predetermined image signal processing and may be stored as an image file.

When the photography control signal is not input, the photography ready state may be continuously maintained. When the photography control signal is input, the image of an object may be captured and the captured image may be input (S23). A scene may be recognized with respect to the captured input image (S24). The scene (e.g., a night view or a portrait scene) may be recognized using histogram distribution per channel of the input image or color information in a color space.

A frame image corresponding to the recognized scene may be produced (S25). The production of the frame image may be performed directly from the image file stored in the SD/CF/SM card 50 or by using a database including meta data.

The transparency of the produced frame image may be determined (S26). The input image and the frame image may be synthesized to generate an output image (S27). A plurality of output images may be generated by changing the transparency of the frame image. In particular, as the resolution of the output image increases, the transparency of the frame image may be increased. Thus, when a thumbnail image of the output image is checked in a reproduction mode, the frame image may appear thick. When a screennail image or the original image is displayed, the frame image may appear thin. Thus, while the original image is effectively displayed on the display, the recognized scene may be effectively recognized by a user.

Referring back to FIG. 15, after the output image is generated, a determination may be made whether the output image is stored (S28). If the output image is determined to be not stored, an image file including the input image (i.e., original image) may be generated and stored (S29). If the output image is determined to be stored, a determination may be made whether the input image is stored (S30). If the input image is determined to be not stored, an image file including the output image may be generated and stored (S31). If the input image is determined to be stored, an image file including both of the input image and the output image may be generated and stored (S32).

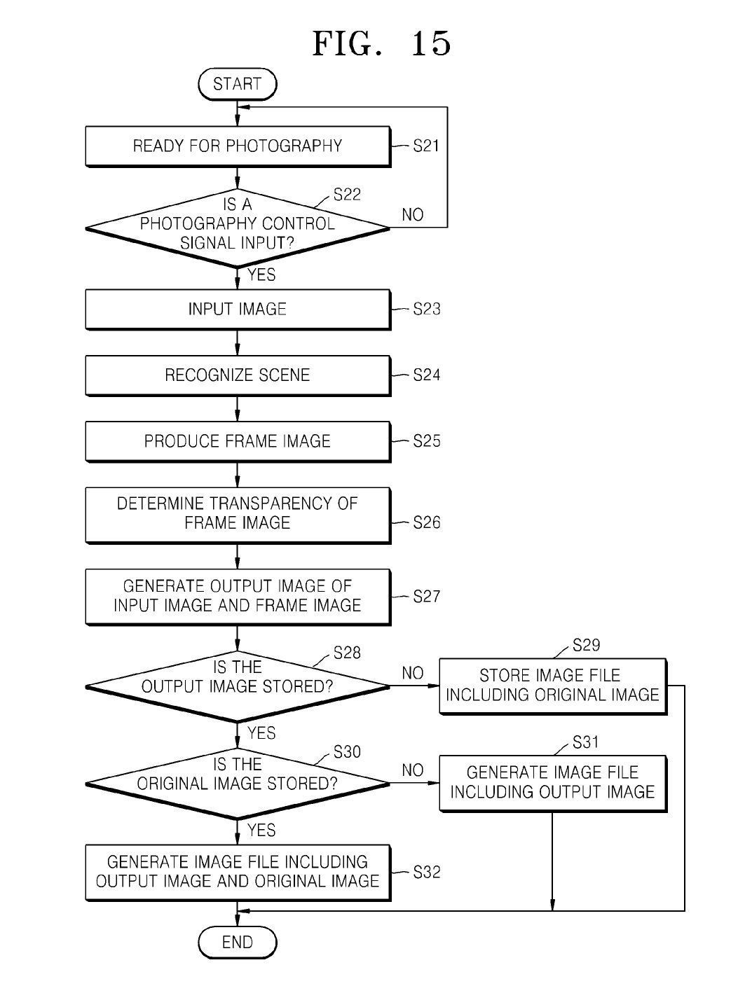

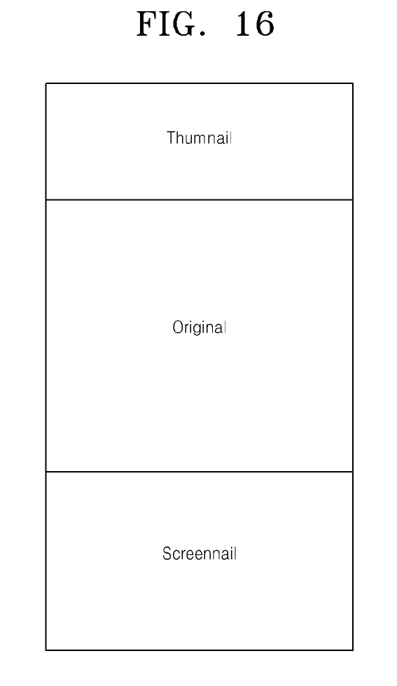

Examples about the structure of an image file including an output image generated in the method of displaying a scene recognition described with reference to FIG. 15 will be described below with reference to FIGS. 16-24.

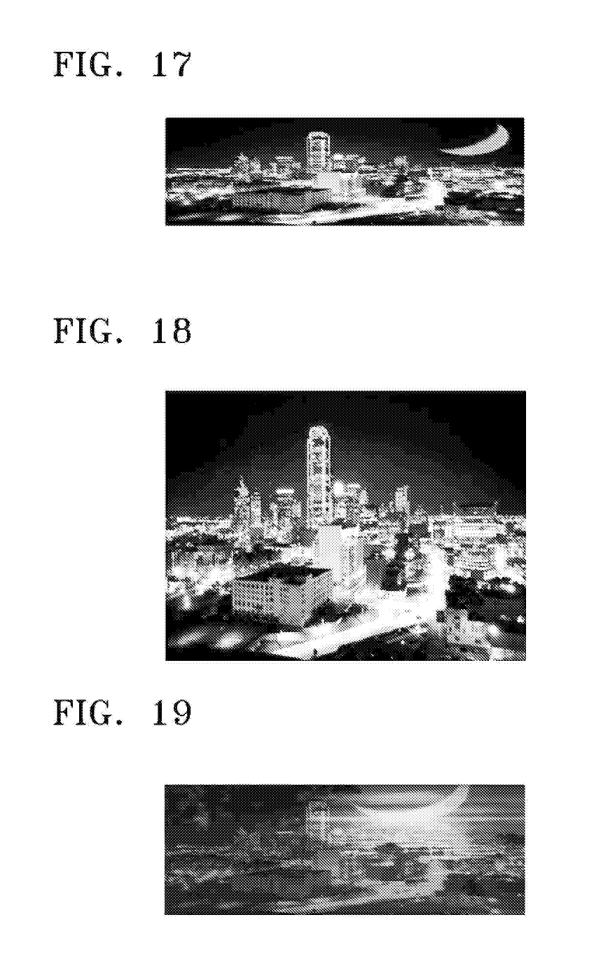

FIG. 16 illustrates an example of the structure of an image file including a thumbnail image, the original image, and a screennail image generated by an exemplary method of displaying scene recognition. The thumbnail image, the original image, and the screennail image included in the image file of FIG. 16 may respectively represent images of FIGS. 17, 18, and 19. FIGS. 17-19 are images corresponding the structure of the image file of FIG. 16. FIGS. 17, 18, and 19 respectively show the thumbnail image, the original image, and the screennail image. The original image may include a synthesis of the frame image and the input image at a ratio of 0:1. Since an image to be displayed may be checked in a preview mode using the thumbnail image, the original image, and the screennail image, the image to be displayed may be confirmed as one indicating a particular scene, such as a night view scene. Also, since only the input image may be the image which is ultimately and substantially needed, an input image that is not overlapped by a frame image may be used to maintain the original image at its maximum resolution and/or quality.

The resolution of the thumbnail image may be higher than that of the screennail image. The transparency of the frame image of the screennail image may be set to be low in comparison with that of the thumbnail image. Thus, as the thumbnail image, the screennail image, and the original image are reproduced and magnified, the frame image may gradually disappear so that only the original image (e.g., the input image) is shown.

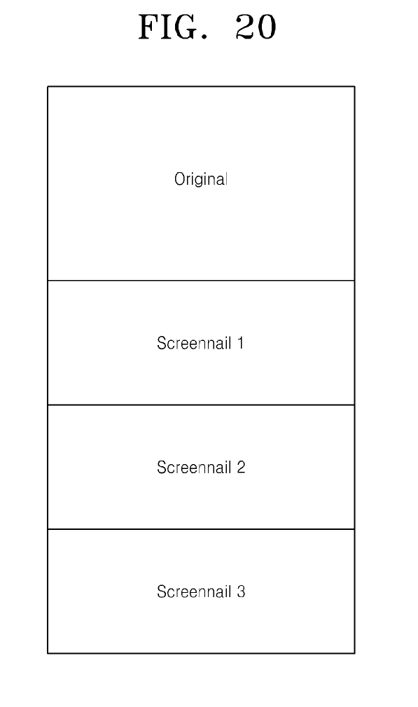

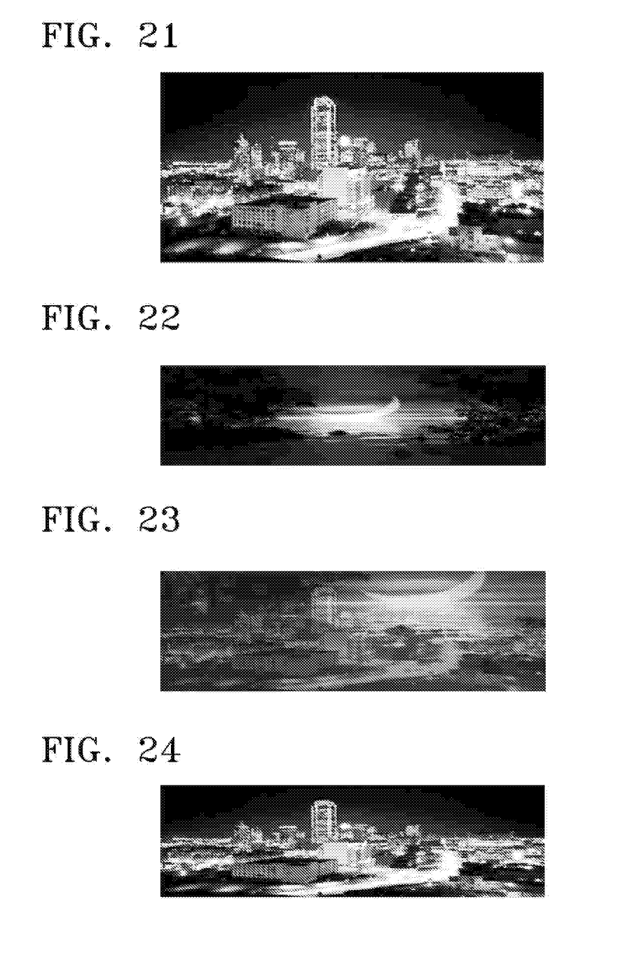

FIG. 20 illustrates another example of the structure of an image file including three sorts of screennail images 1, 2, and 3 and the original image generated by an exemplary method of displaying scene recognition. FIG. 21 illustrates the original image. FIG. 22 illustrates the first screennail image Screennail 1 of FIG. 20. FIG. 23 illustrates the second screennail image Screennail 2 of FIG. 20. FIG. 24 illustrates the third screennail image Screennail 3 of FIG. 20. In the present embodiment, an image file including screennail images which have the same resolution but different transparencies of their respective frame images, is illustrated. Thus, in reproducing the image file, the first screennail image Screennail 1 having a frame image that appears thick (FIG. 22) may be displayed according to the selection of a user, or the third screennail image Screennail 3 in which the frame image disappears (FIG. 24) may be displayed.

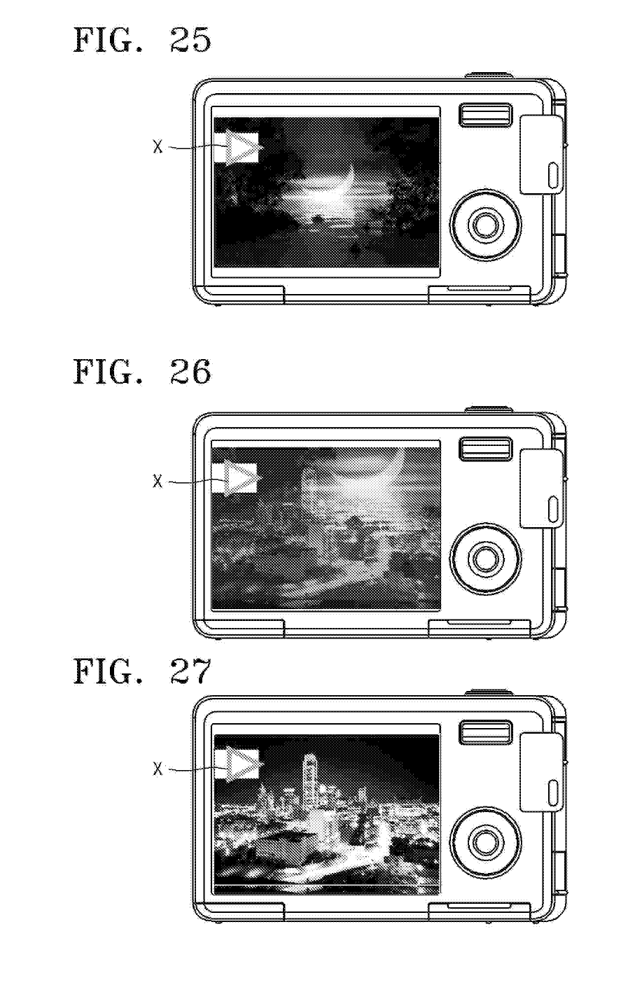

FIGS. 25-27 are images for explaining exemplary steps of reproducing the image file of FIG. 20 in a digital camera. In detail, referring to FIGS. 25-27, when the image file of FIG. 20 is reproduced in a digital camera, according to the selection of a user, the first screennail image Screennail 1, the second screennail image Screennail 2, or the third screennail image Screennail 3 may be displayed. FIGS. 25, 26, and 27 respectively illustrate the first screennail image Screennail 1, the second screennail image Screennail 2, and the third screennail image Screennail 3.

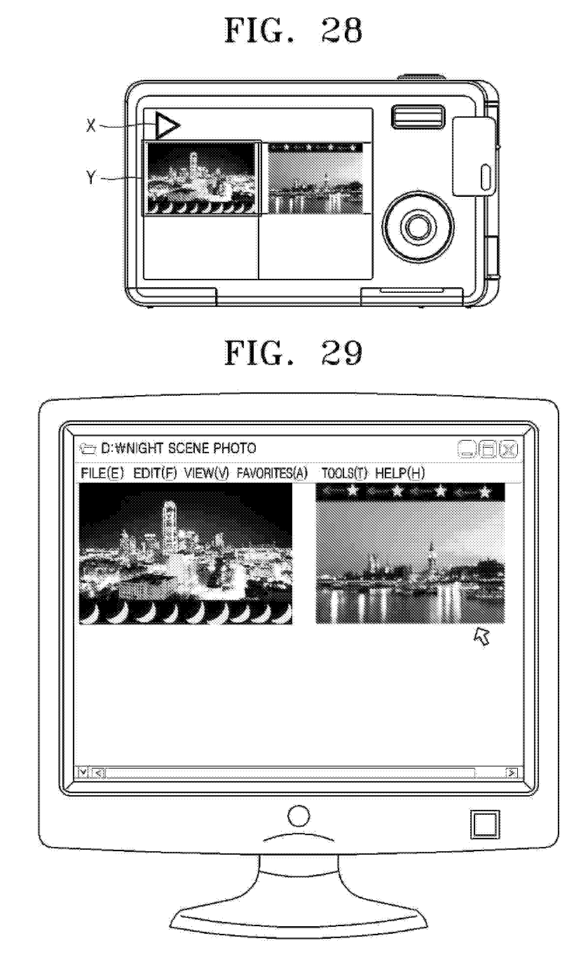

FIG. 28 illustrates output images generated in an exemplary method of displaying scene recognition, and displayed in a preview mode in a digital camera. In a digital camera, a thumbnail image may be displayed in the preview mode. For example, referring to FIG. 28, the thumbnail images of the images of FIGS. 11 and 12 may be displayed on the LCD. A selection mark Y may be moved by using a movement icon X and, when a thumbnail image that overlaps the selection mark Y is selected, the original image or screennail image corresponding to the thumbnail image may be displayed. An output image including only an input image or in which a frame image appears thin may be displayed.

FIG. 29 illustrates output images generated in an exemplary method of displaying scene recognition, and displayed in a preview mode on an external monitor. As in the digital camera of FIG. 28, a thumbnail image in which a frame image appears thick may be displayed and, when any one of the thumbnail images is selected by using a mouse, the original image or screennail image corresponding to the thumbnail image may be displayed.

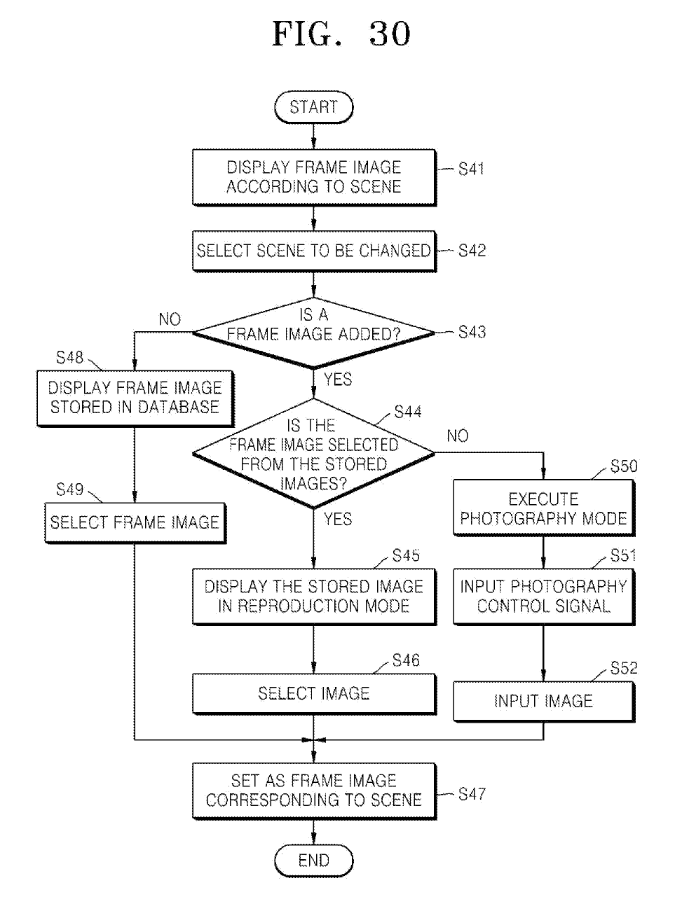

FIG. 30 is a flowchart for explaining another exemplary method of displaying scene recognition in a digital image signal processing apparatus. In the present embodiment, steps of setting or changing a frame image according to a scene will be mainly described.

Referring to FIG. 30, a frame image according to a scene may be displayed (S41). At least one frame image according to the scene may be displayed and a frame image corresponding to a plurality of scenes may be displayed.

A scene whose frame image is to be changed may be selected (S42). For example, a “night view” scene may be selected. A determination may be made whether a frame image is to be added (e.g., added to a database 87c) to correspond to the selected scene (S43). If a determination is made that a frame image is to be added, a determination may be made whether the frame image to be added is to be selected from the previously stored images (S44). If the frame image to be added is determined to be selected from the stored images, a stored image may be displayed in a reproduction mode (S45). Any one of a plurality of displayed stored images may be selected (S46). A selected image may be set as a frame image corresponding to the scene to be changed (S47).

If a determination is made that a frame image is not to be added in Operation S43, at least one frame image corresponding to the scene to be changed may be displayed from a database (e.g., database 87c) (S48). A frame image may be selected (S49) and the selected frame image may be set as a frame image corresponding to the scene to be changed (S47).

If the frame image to be added is determined to be selected from the stored images is determined to be not selected from the previously stored images in Operation S44, a photography mode may be executed (S50). A photography control signal may be input (S51) and an image may be captured. Thus, an image may be input (S52) and the input image may be set as a frame image corresponding to the scene to be changed (S47).

Therefore, according to the above-described embodiment, a frame image corresponding to a scene may be set or changed.

As described above, according to embodiments of the present invention, since a frame image displaying information regarding a scene recognition of an input image obtained by photographing an object may be customized by a user, the user may easily recognize the scene of the input image. Also, since the frame image may be displayed in conjunction with the input image by adjusting the transparency of the frame image or the frame image may be displayed in an edge area of the input image, the information regarding the scene recognition may be delivered to the user while minimizing an influence on the displaying of the input image.

Functional programs, codes, and code segments for accomplishing the present invention can be easily construed by programmers of ordinary skill in the art to which the present invention pertains. Embodiments of the present invention may be implemented as one or more software modules. These software modules may be stored as program instructions executable by a processor on a computer-readable storage medium, where the program instructions stored on this medium can be read by a computer, stored in a memory, and executed by the processor. For example, the software modules may include computer-readable code constructed to perform the operations included in a method according to the present invention when this code is read from the computer-readable storage medium via the DSP 80 of FIG. 1. Examples of the storage medium include magnetic storage media (e.g., floppy disks, hard disks, or magnetic tape), optical storage media (e.g., CD-ROMs or digital versatile disks (DVDs)), and electronic storage media (e.g., integrated circuits (IC's), ROM, RAM, EEPROM, or flash memory). The storage medium may also be distributed over network-coupled computer systems so that the program instructions are stored and executed in a distributed fashion.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements, the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

It will be recognized that the terms “comprising,” “including,” and “having,” as used herein, are specifically intended to be read as open-ended terms of art. The use of the terms “a” and “and” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

What is claimed is:

1. A method of displaying scene recognition of a digital image signal processing apparatus, the method comprising:
generating an input image;
recognizing a scene of the input image;
producing a frame image corresponding to the recognized scene;
synthesizing the frame image and the input image to generate an output image; and
displaying the output image.

2. The method of claim 1, wherein the frame image and the input image are presented as image data in a same storage format.

3. The method of claim 1, further comprising adjusting transparency of the frame image, wherein the frame image having the adjusted transparency is synthesized with the input image to generate the output image.

4. The method of claim 1, further comprising:
generating the frame image;
setting the generated frame image as a frame image corresponding to a scene; and
generating a database regarding the generated frame image according to the scene.

5. The method of claim 4, wherein the database includes at least one frame image corresponding to a scene.

6. The method of claim 5, further comprising deriving a first frame image corresponding to a first scene.

7. The method of claim 6, further comprising changing the first frame image to a second frame image, produced with respect to the first scene.

8. The method of claim 1, wherein generating the input image comprises photographing an object.

9. The method of claim 1, further comprising:
generating an image file including the output image; and
storing the image file on a storage medium.

10. The method of claim 1, further comprising:
generating a plurality of output images by synthesizing the input image and the frame image corresponding to the recognized scene by varying transparency of the frame image corresponding to the recognized scene;
generating an image file including the plurality of output images; and
storing the image file on a storage medium.

11. The method of claim 10, wherein generating a plurality of output images further comprises:
generating a first output image having a first resolution by synthesizing the input image and the frame image having a first transparency; and
generating a second output image having a second resolution by synthesizing the input image and a second frame image having a second transparency.

12. The method of claim 11, wherein the first transparency decreases as the first resolution increases.

13. The method of claim 11, wherein the image file further includes a third output image having a third resolution, the third output image comprising the input image without a frame image.

14. The method of claim 11, further comprising:
restoring at least one of the output images from the image file; and
displaying a restored output image.

15. The method of claim 14, further comprising receiving an input magnification control signal, wherein restoring the at least one of the output images comprises restoring an output image having a resolution according to the magnification control signal.

16. The method of claim 14, further comprising receiving an input preview control signal, wherein restoring the at least one of the output images comprises restoring an output image having a relatively low resolution according to the preview control signal.

17. A computer readable storage medium having stored thereon a program, the program being executable by a processor to perform a method of displaying scene recognition of a digital image signal processing apparatus, the method comprising:
generating an input image;
recognizing a scene of the input image;
producing a frame image corresponding to the recognized scene;
synthesizing the frame image and the input image to generate an output image; and
displaying the output image on a display unit.

18. A digital image signal processing apparatus comprising:
an input image generation unit configured to generate an input image;
a scene recognition unit communicatively coupled with the input image generation unit and configured to recognize a scene from the input image;
a frame image production unit communicatively coupled with the scene recognition unit and configured to produce a frame image corresponding to the recognized scene;
an output image generation unit communicatively coupled with the input image generation unit and the frame image production unit, the output image generation unit configured to synthesize the frame image and the input image to generate an output image; and
a display control unit communicatively coupled with the output image generation unit and configured to control the output image to be displayed on a display unit.

19. The digital image signal processing apparatus of claim 18, wherein the frame image and the input image are presented as image data in a same storage format.

20. The digital image signal processing apparatus of claim 18, further comprising a frame image setting unit configured to set a frame image to correspond to a type of scene.

21. The digital image signal processing apparatus of claim 18, further comprising a database configured to store a frame image according to a type of the scene.

22. The digital image signal processing apparatus of claim 21, wherein the database is further configured to store a plurality of frame images corresponding to a scene, and further comprising a frame image changing unit configured to change a first frame image corresponding to the scene to a second frame image corresponding to the scene.

23. The digital image signal processing apparatus of claim 18, further comprising:
a transparency adjustment unit configured to adjust transparency of the frame image; and
a synthesis unit configured to generate an output image by synthesizing the frame image and the input image.

24. The digital image signal processing apparatus of claim 23, wherein the synthesis unit is further configured to generate a plurality of output images, the plurality of the output images including a plurality of frame images having different transparencies from each other.

25. The digital image signal processing apparatus of claim 24, wherein the synthesis unit is further configured to generate a first output image having a first resolution including the input image and a first frame image having a first transparency, and a second output image having a second resolution including the input image and a second frame image having a second transparency.

26. The digital image signal processing apparatus of claim 25, wherein the synthesis unit is further configured to generate a third output image having a third resolution comprising the input image without a frame image.

27. The digital image signal processing apparatus of claim 18, further comprising an encoder communicatively coupled with the output image generation unit and configured to generate an image file including the output image.

28. The digital image signal processing apparatus of claim 27, further comprising a decoder configured to restore the output image from an image file.

29. The digital image signal processing apparatus of claim 28, wherein the decoder is further configured to restore the output image having a relatively high resolution according to a magnification control signal, and wherein the display control unit is further configured to control a display unit to display the restored output image.

30. The digital image signal processing apparatus of claim 28, wherein the decoder is further configured to restore the output image having a relatively low resolution according to a preview control signal, and wherein the display control unit is further configured to control a display unit to display the restored output image.
